(19) United States
(12) Patent Application Publication
(10) Pub. No.: US 2024/0001786 A1
(43) Pub. Date: Jan. 4, 2024

(54) BATTERY CHARGER FOR MOTOR VEHICLE, ASSOCIATED VEHICLE AND IMPLEMENTATION METHOD

(71) Applicant: RENAULT S.A.S, Boulogne Billancourt (FR)

(72) Inventor: Serge LOUDOT, Villiers le Bacle (FR)

(73) Assignee: RENAULT S.A.S, Boulogne Billancourt (FR)

(21) Appl. No.: 18/253,599

(22) PCT Filed: Nov. 19, 2021
(86) PCT No.: PCT/EP2021/082379

§ 371 Date: May 19, 2023

(30) Foreign Application Priority Data
Nov. 23, 2020 (FR) FR2011983

(51) Int. Cl. B60L 53/22; H02J 7/06

(52) U.S. Cl. CPC B60L 53/22; B60Y 2200/91; H02J 2207/20; H02J 7/06

(57) ABSTRACT

A battery charger is for a motor vehicle that includes a primary electrical power converter and a secondary electrical power converter connected by a transformer. The charger includes: a compensating primary electrical power converter, having a high-frequency switching stage connected at the output to the transformer; a filter capacitor connected between two input terminals of the high-frequency switching stage of the compensating primary converter; a compensating secondary electrical power converter connected to the compensating primary converter via the transformer; and a switchable storage capacitor connected between the two input terminals of the high-frequency switching stage of the compensating primary converter. The compensating secondary electrical power converter and the high-frequency switching stage of the primary compensation converter charge or discharge the storage capacitor as a function of an instantaneous power setpoint.

The present invention relates to a battery charger for a motor vehicle.

The present invention relates more particularly to a reversible insulated battery charger for charging batteries, to a vehicle comprising such a charger and to a method for implementing such a charger.

Motor vehicles may be equipped with an electrical powertrain comprising electric motors or a hybrid powertrain combining, for example, an internal combustion engine and electric motors, with traction batteries for storing energy in order to supply power to the electric motors, and with chargers for recharging the traction batteries.

Document EP3317955 discloses a reversible insulated battery charger 1 for charging a battery from a single-phase or three-phase electrical network.

FIG. 1 illustrates the charger 1 connected at input to a single-phase network R1 (single-phase mode), and at output to a battery BAT.

The charger 1 comprises a primary circuit 3 connected to the network R1 and a secondary circuit 4 connected to the primary circuit 3 via single-phase transformers 5, 6 and 7, and an active filter 8.

The primary circuit 3 comprises three identical reversible primary electrical power converters 9, 10, 11 each connected at input to the phase L1 and to the neutral N of the network R1.

Each primary electrical power converter 9, 10, 11 is connected at output to a primary coil forming the primary winding of the transformer 5, 6, 7.

The first secondary circuit 4 comprises three identical reversible secondary power converters 12, 13, 14 each connected at input to a secondary coil forming the secondary winding of the transformer 5, 6, 7, each secondary power converter 12, 13, 14 also being connected to the battery BAT.

The charger 1 charges the battery BAT from the network R1.

The active filter 8 makes it possible to compensate for power pulses when the charger 1 is supplied with power by the network R1.

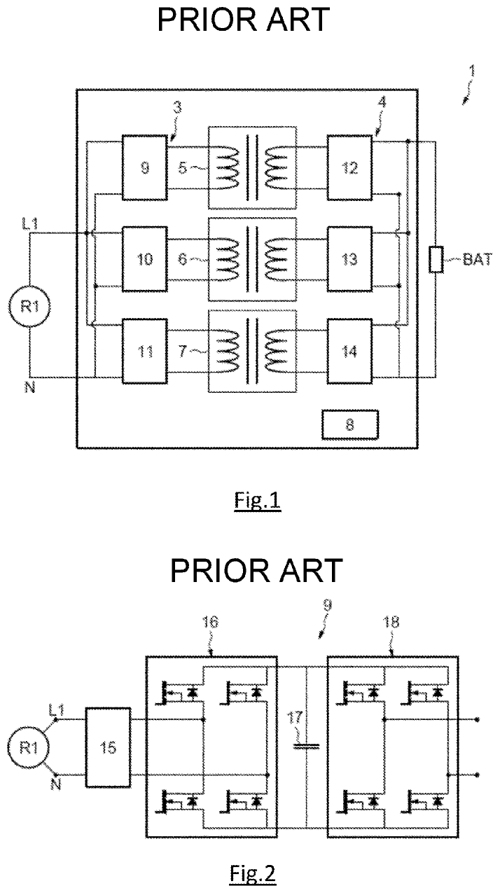

FIG. 2 illustrates the architecture of the primary electrical power converter 9.

The primary electrical power converter 9 comprises an input filter 15 connected at input to the neutral N and to the phase L1 of the network R1, a low-frequency switching stage 16, a filter capacitor 17 and a high-frequency switching stage 18.

The low-frequency switching stage 16 is connected at input to the filter 15 and comprises two output terminals connected to two input terminals of the high-frequency switching stage 18, outputs of the high-frequency switching stage 18 being connected to the primary coil of the transformer 5.

The capacitor 17 is connected between the two output terminals of the low-frequency switching stage 16.

The high-frequency switching stage 18 and low-frequency switching stage 16 each comprise four switching cells formed from diodes and transistors.

The low-frequency switching stage 16 operating at low frequency, for example 50 Hz or 60 Hz, delivers a unipolar voltage at input of the high-frequency stage 18 operating at high frequency, for example from 135 kHz to 500 kHz.

When the charger 1 is supplied with power by a three-phase electrical power supply network (three-phase mode), each primary electrical power converter 9, 10, 11 is connected to a different phase of the three-phase network.

However, when the charger 1 operates in single-phase mode, an active filter may be needed to compensate for power pulses, the primary converters each being connected to the phase L1.

Installing the filter in the charger requires an electronic function associated with a dedicated space for the active filter and complicates the operation of the charger.

Furthermore, using the charger in single-phase mode or in three-phase mode requires implementing three single-phase transformers each requiring a dedicated space in the charger and worsening the efficiency of the charger 1.

It is therefore proposed to overcome all or some of the drawbacks of the charging devices according to the prior art, in particular by proposing a compact charger having improved efficiency.

In light of the above, the invention proposes a battery charger for a motor vehicle, comprising a primary electrical power converter and a secondary electrical power converter that are connected by a transformer, the primary power converter and the secondary power converter being configured to transfer the maximum instantaneous power delivered by an electrical power supply network or a battery, respectively, to the battery or to the electrical power supply network.

The charger comprises:
at least one primary compensation electrical power converter comprising a high-frequency switching stage connected at output to the transformer,
a filter capacitor connected between two input terminals of the high-frequency switching stage of the primary compensation converter,
at least one secondary compensation electrical power converter connected to the primary compensation converter via a transformer, and
a switchable storage capacitor connected between the two input terminals of the high-frequency switching stage of the primary compensation converter,
the secondary compensation electrical power converter and the high-frequency switching stage of the primary compensation converter being configured to charge or discharge the storage capacitor on the basis of an instantaneous power setpoint.

According to one feature, the charger furthermore comprises a second switchable storage capacitor connected between the two input terminals of a second high-frequency switching stage of a second primary compensation electrical power converter, and a second secondary compensation electrical power converter connected to the second primary compensation converter via a transformer, the second secondary compensation converter and the second high-frequency switching stage of the second primary compensation converter being configured to charge or discharge the second storage capacitor on the basis of the instantaneous power setpoint equal to a constant first power threshold.

Preferably, the primary electrical power converter comprises a third high-frequency switching stage, the transformer to which the primary electrical power converter is connected is of three-phase type and comprises three power pads, a free flux pad, three primary coils each wound around a different power pad and connected to a different high-frequency switching stage, and three secondary coils each wound around a different power pad, each secondary coil being connected to the secondary electrical power converter or to one of the secondary compensation converters, the power pads being arranged in the transformer such that the mutual inductances between the primary coils are the same, this condition being satisfied by an equal distance between the power pads, and such that the free flux pad is equidistant from each of the power pads.

Another subject of the invention is a motor vehicle comprising a battery and a charger as defined above, the battery being connected to the secondary circuit.

Another subject of the invention is a method for exchanging electrical energy between a battery for a motor vehicle and a single-phase electrical power supply network both connected to a battery charger, comprising controlling a primary electrical power converter and a secondary electrical power converter so as to transfer the maximum instantaneous power delivered by an electrical power supply network or a battery, respectively, to the battery or to the electrical power supply network.

The method comprises:
switching a switchable storage capacitor arranged in parallel with a filter capacitor between two input terminals of a high-frequency switching stage of at least one primary compensation electrical power converter of the charger such that the storage capacitor is connected to the two input terminals, and
controlling at least one secondary compensation electrical power converter of the charger connected to the primary compensation power converter via a transformer of the charger and controlling the high-frequency switching stage of the primary compensation converter so as to charge or discharge the storage and filter capacitors on the basis of an instantaneous power setpoint.

According to one feature, the method furthermore comprises:
switching a second switchable storage capacitor of a second primary compensation electrical power converter such that the second storage capacitor is connected to the two input terminals of a second high-frequency switching stage of the second primary compensation electrical power converter, and
controlling a second secondary compensation electrical power converter connected to the primary compensation electrical power converter via the transformer and controlling the second high-frequency switching stage of the second primary compensation converter so as to charge or discharge the second storage capacitor on the basis of the instantaneous power setpoint.

Preferably, the primary electrical power converter comprises a third high-frequency switching stage, and the transformer is of three-phase type and comprises three power pads, a free flux pad, three primary coils each wound around a different power pad and connected to a different high-frequency switching stage, and three secondary coils each wound around a different power pad, each secondary coil being connected to the secondary electrical power converter or to one of the secondary compensation converters, the power pads being arranged in the transformer such that the mutual inductances between the primary coils are the same, this condition being satisfied by an equal distance between the power pads, and such that the free flux pad is equidistant from each of the power pads.

Advantageously, when the instantaneous power delivered by the single-phase electrical power supply network is greater than the instantaneous power setpoint equal to a first power threshold, each secondary compensation electrical power converter and the high-frequency switching stage of each primary compensation converter are controlled so as to charge each switchable storage capacitor and each filter capacitor.

Preferably, when the instantaneous power delivered by the single-phase electrical power supply network is less than the instantaneous power setpoint equal to a first power threshold, each secondary compensation electrical power converter and the high-frequency switching stage of each primary compensation electrical power converter are controlled so as to discharge each switchable storage capacitor and each filter capacitor.

Advantageously, when the instantaneous power delivered by the battery is greater than the instantaneous power setpoint equal to a first power threshold, each secondary compensation electrical power converter and the high-frequency switching stage of each primary compensation electrical power converter are controlled so as to charge each switchable storage capacitor and each filter capacitor such that the instantaneous electrical power received by the single-phase electrical network is equal to the second power threshold.

Preferably, when the instantaneous power delivered by the battery is less than the power threshold equal to a first power threshold, each secondary compensation electrical power converter and the high-frequency switching stage of each primary compensation electrical power converter are controlled so as to discharge each switchable storage capacitor and each filter capacitor.

Other aims, features and advantages of the invention will become apparent on reading the following description, which is given merely by way of non-limiting example, and with reference to the appended drawings, in which:

FIG. 1, which has already been mentioned, schematically illustrates a battery charger according to the prior art;

FIG. 2, which has already been mentioned, schematically illustrates a primary electrical power converter according to the prior art;

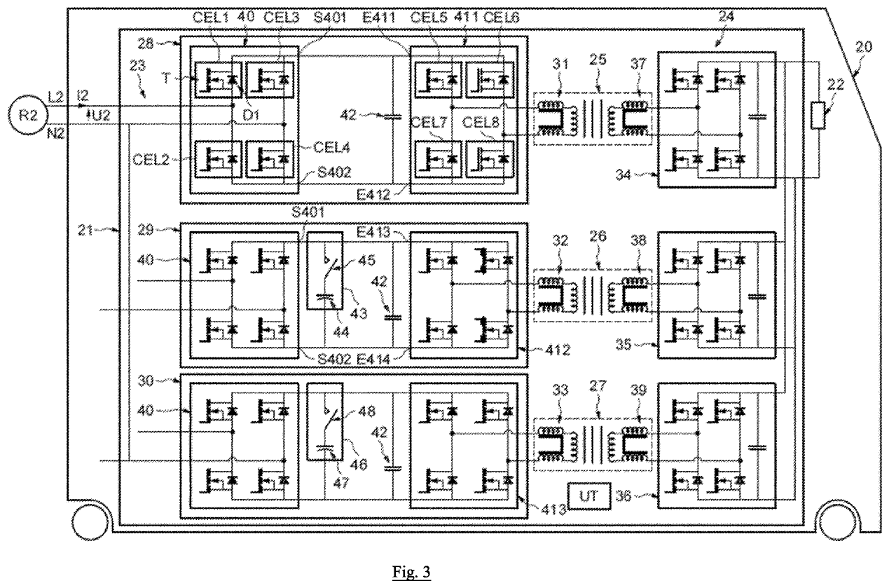

FIG. 3 schematically illustrates one embodiment of a battery charger according to the invention;

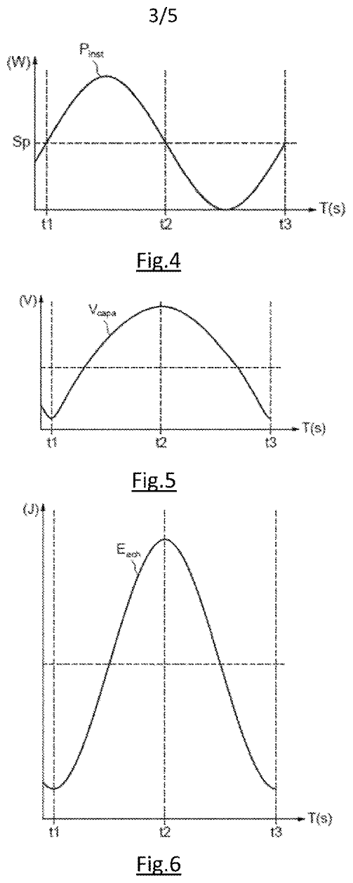

FIG. 4 schematically illustrates one example of the temporal evolution of the instantaneous power delivered by the single-phase network;

FIG. 5 illustrates one example of the temporal evolution of the voltage across the terminals of the storage capacitors according to the invention;

FIG. 6 illustrates one example of the temporal evolution of the energy exchanged by the storage capacitors according to the invention;

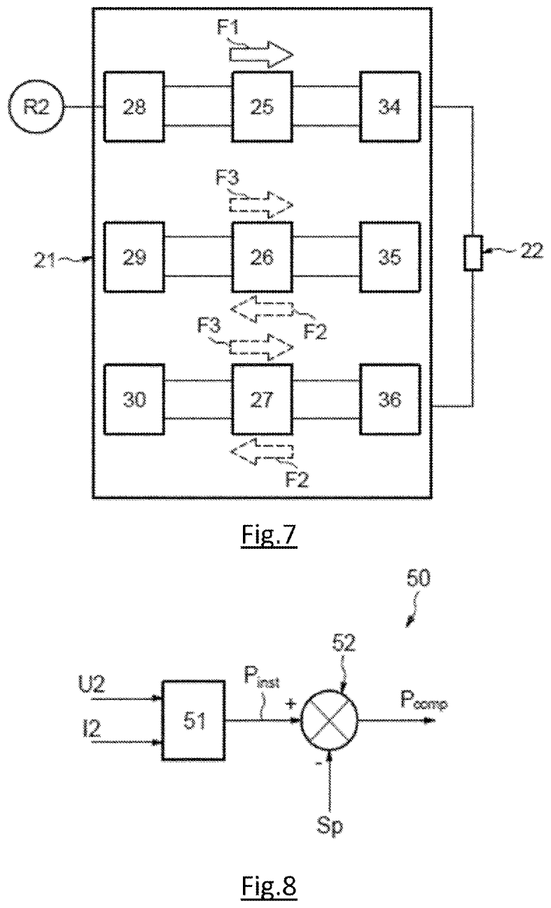

FIG. 7 illustrates one example of instantaneous electrical power exchanges between the various elements of the charger according to the invention;

FIG. 8 and

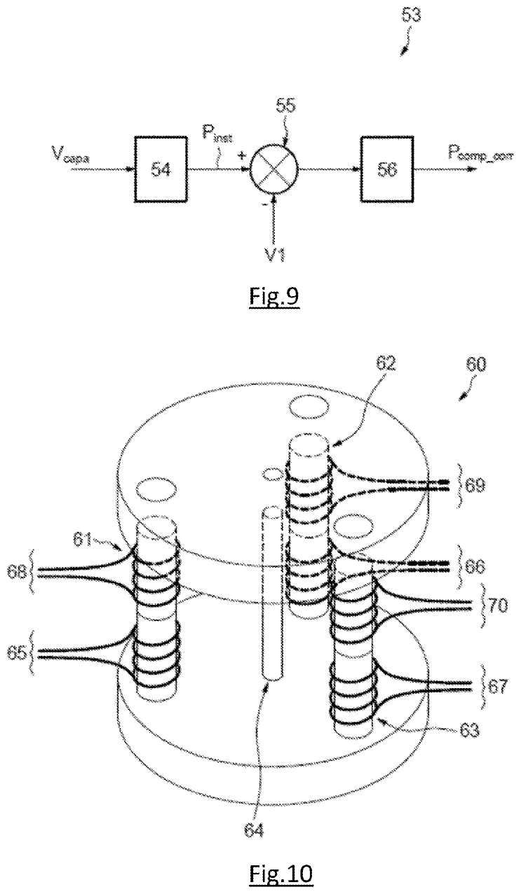

FIG. 9 illustrate one example of control loops of the charger according to the invention, and

FIG. 10 schematically illustrates one embodiment of the three-phase transformer.

FIG. 3 illustrates a single-phase electrical network R2 delivering for example 16 amperes or 32 amperes on its phase L2, and a hybrid or electric motor vehicle 20 comprising a first embodiment of a reversible battery charger 21, supplied with power by the electrical network R2, for recharging or discharging a battery 22 connected to the charger 21.

It is assumed hereinafter that the network R2 delivers a current 12 with an average intensity of 16 amperes and a sinusoidal voltage U2 with an RMS value of 250 volts.

As a variant, the energy contained in the battery 22 is delivered by the charger 21 to the network R2.

The charger 21 comprises a primary circuit 23 connected to the network R2 and a secondary circuit 24 connected to the primary circuit 23 via a transformer comprising three single-phase transformers 25, 26 and 27, and a processing unit UT.

The primary circuit 23 comprises a primary electrical power converter 28 and two primary compensation converters 29, 30, the primary converter 28 being connected at input to the phase L2 of the network R1, and the primary converter and the primary compensation converters being connected at input to the neutral N2 of the network R2.

The primary electrical power converter 28 and each primary compensation electrical power converter (corresponding to the converters used on the other two supply phases during a three-phase load) 29, 30 are connected at output to a respective primary coil 31, 32, 33 supplied with power by the respective primary electrical power converter 28, 29, 30, each primary coil forming a primary winding of a single-phase transformer 25, 26, 27.

The first secondary circuit 24 comprises a secondary power converter 34, a first and a second secondary compensation power converter 35, 36, the secondary power converter 34 being connected to the primary converter 28 via a first secondary coil 37, a first secondary compensation converter 35 being connected to a first primary compensation converter 29 via a second secondary coil 38 and the second secondary compensation converter 36 being connected to the second primary compensation converter 30 via a third secondary coil 39, each secondary power converter 34, 35, 36 also being connected to the battery 22.

The secondary coils 37, 38, 39 respectively form a secondary winding ofthe single-phase transformers 25, 26, 27 without magnetic coupling to the primary.

The secondary electrical power converter 34 and the secondary electrical power converters 35, 36 have an identical, reversible architecture and are for example formed from diodes and transistors.

The primary and secondary electrical power converters are driven by the processing unit UT in a switching mode known to those skilled in the art as zero-voltage switching (ZVS) or soft switching, reducing switching losses.

The charger 21 charges the battery 22 from the network R2.

The primary converter 28 comprises a low-frequency switching stage 40 connected at input to the electrical power supply network R2, a high-frequency switching stage 411 connected at output to the first transformer 25, and a filter capacitor 42 formed for example based on plastic metallized films.

The low-frequency switching stage 40 comprises two connection terminals S401, S402 each connected to a different input terminal E411, E412 of the high-frequency switching stage 411.

The filter capacitor 42 is connected between the two connection terminals S401, S402 of the low-frequency switching stage 40.

The low-frequency switching stage 40 comprises four identical low-frequency switching cells CEL1 to CEL4 each comprising a unipolar transistor T comprising a freewheeling diode D1.

An input of a first low-frequency cell CEL1 and an output of a second low-frequency cell CEL2 are connected to the phase L2.

An input of a third low-frequency cell CEL3 and an output of the fourth low-frequency cell CEL4 are connected to the neutral N2.

An output of the first cell CEL1 and of the third cell CEL3 are connected to a first connection terminal S401.

An input of the second cell CEL2 and of the fourth cell CEL4 are connected to the second connection terminal S402.

The cells CEL1 to CEL4 of the low-frequency switching stage 40 operate at low frequency, the switching frequency being equal to that of the network R2, for example 50 Hz.

The low-frequency switching stage 40 rectifies the voltage delivered by the network R2 and the filter capacitor 42, which is of low value (for example 10 μF), makes it possible to reduce the impedance of the switching loop of the converters 40 and 411, such that the high-frequency switching stage 411 receives, at input, a unipolar voltage that makes it possible to form the high-frequency switching stage from unipolar components.

The high-frequency switching stage 411 comprises four identical high-frequency switching cells CEL5 to CEL8 each comprising a unipolar transistor associated with a freewheeling diode.

An output of a fifth cell CEL5 and of a sixth cell CEL6 are connected to a first input terminal E411 of the high-frequency switching stage 411.

An input of a seventh cell CEL7 and of the eighth cell CEL8 are connected to the second input terminal E412 of the high-frequency switching stage 411.

An input of the fifth cell CEL5 and an output of the seventh cell CEL7 are connected to a first end of the coil 31, and an input of the sixth cell CEL6 and an output of the eighth cell CEL8 are connected to the second end of the coil 31.

The cells CEL5 to CEL8 of the high-frequency switching stage 411 operate at high frequency, for example at 150 kHz.

The primary converter 28 and the secondary converter 34 connected by a first single-phase transformer 25 are driven by the processing unit UT so as to transfer the maximum instantaneous power delivered by the electrical power supply network R2 to the battery 22.

The processing unit UT delivers for example, to each converter 34, 411, a square-wave voltage comprising a duty cycle of 0.5, and controls the phase shift between the two square-wave voltages.

The first primary compensation converter 29 comprises the low-frequency switching stage 40 connected to a second high-frequency switching stage 412 and the filter capacitor 42 arranged as in the first converter 28.

The architecture of the second high-frequency switching stage 412 is identical to that of the first high-frequency switching stage 411, the second stage 412 comprising a first input terminal E413 and second input terminal E414.

The first primary compensation converter 29 furthermore comprises a first switchable storage capacitor 43 comprising a first storage capacitor 44 and a first switch 45 connected to a first end of the capacitor 44 and to one of the connection terminals S401, S402 of the low-frequency switching stage 40, the second end of the storage capacitor 44 being connected to the other connection terminal S402, S401 of the low-frequency switching stage 40.

The first storage capacitor 44 may be of the same type as the filter capacitor 42 or of electrolytic capacitor type, so as to increase the stored energy density of the storage capacitor 44.

The second primary compensation converter 30 has an architecture identical to the first converter 29 and comprises a second switchable storage capacitor 46 comprising a second storage capacitor 47, a second switch 48, and a third high-frequency switching stage 413 with an architecture identical to that of the second high-frequency switching stage 412.

The capacitances C44 and C47 of the first and second storage capacitors 44, 47 may be identical or different.

It is assumed hereinafter that the first and second storage capacitors 44, 47 are identical.

Since the charger 21 charges the battery 22 from the single-phase electrical network R2, the switches 45, 48 are switched by the processing unit UT such that the storage capacitors 44, 47 connect the terminals S401, S402 of the low-frequency switching stages 40.

The processing unit UT drives the first and second secondary compensation converters 35, 36 and the first and second primary compensation converters 29, 30 so as to charge or discharge the storage capacitors 44, 47 and filter capacitors 42 such that the instantaneous electrical power received or supplied by the battery 22 is constant and equal to a first power threshold Sp equal for example to the average power delivered by the single-phase network R2, for example 4000 watts when the network R2 delivers an average of 16 amperes RMS and 250 volts.

The first and second secondary compensation converters 35, 36, the first and second primary compensation converters 29, 30, the storage capacitors 44, 47 and the filter capacitors 42 forming a compensation device compensate for power pulses at a frequency twice that of the single-phase network R2.

The additional capacitance Cadd, equal to the sum of the minimum capacitances Cmin44 and Cmin47 of the first and second storage capacitors 44, 47, is determined such that the first and second storage capacitors 44, 47 compensate for instantaneous power variations above or below the power threshold Sp.

The minimum capacitances Cmin44 and Cmin47 of the first and second storage capacitors 44, 47 are determined such that:

$$Cadd \geq Cmin 44 + Cmin 47 = 2 \cdot \frac{Emax}{{V}_{1}^{2}} - 2 \cdot C 42 \qquad ( 1 )$$

where V₁ is the maximum voltage admissible to the capacitors of the charger 21 and the transistors of the charger 21 and Emax is the maximum energy exchanged when the current and the voltage delivered by the network R2 have reached their highest value.

As a variant, the second primary compensation converter 30 does not comprise the second switchable storage capacitor 46, the second converter 30 having the same architecture as the first primary converter 28. The processing unit UT then drives the first secondary compensation converter 35 and the first primary compensation converter 29 so as to charge or discharge the storage capacitor 44 of the first primary compensation converter 29 such that the instantaneous electrical power received by the battery 22 is constant and equal to the power threshold Sp, the minimum capacitance Cmin44 of the first storage capacitor 44 being equal to:

$$Cmin 44 = 2 \cdot \frac{Emax}{{V}_{1}^{2}} - C 42 \qquad ( 2 )$$

the additional storage capacitance Cadd being equal to Cmin44.

When the network R2 delivers 16 amperes, the additional capacitance Cadd is for example equal to 160 μF, and to 320 μF when the network R2 delivers 32 amperes.

The compensation device comprises the primary and secondary compensation converters that are not connected to the phase of the single-phase network R2 (free phase), said converters being driven in ZVS mode in order to make the efficiency of the compensation device high.

Moreover, since the compensation device requires only the addition of at least one switchable storage capacitor 43 compared to a charger from the prior art, the size of the charger 21 is substantially equivalent to a charger from the prior art not comprising a pulse compensation device.

According to another embodiment, the charger 21 transfers electrical energy from the battery 22 to the network R2 by implementing the compensation device.

When the charger 21 is connected to a three-phase network, the switches 45, 48 are open, the primary converter 28 and each primary compensation converter 29 and 30 being connected to a different phase of the three-phase network and to the neutral of the three-phase network, the processing unit UT driving the primary and secondary converters so as to charge the battery 22 from the three-phase network. Since the electrical power exchanged by the three-phase network is constant, the compensation device may be deactivated.

FIGS. 4, 5, 6 and 7 illustrate one example of a method for exchanging electrical energy between the battery 22 and the single-phase electrical power supply network R2 implementing the charger 21.

It is assumed that the charger 21 charges the battery 22 from the network R2 connected to the primary converter 28 and comprises the two storage capacitors 44, 47 connected between the terminals of the low-frequency switching stages.

FIG. 4 illustrates one example of the temporal evolution of the instantaneous power Pinst delivered by the network R2, FIG. 5 illustrates one example of the temporal evolution of the voltage Vcapa across the terminals of the storage capacitors 44, 47, FIG. 6 illustrates the temporal evolution of the energy exchanged Eech by the storage capacitors 44, 47, and FIG. 7 illustrates one example of instantaneous electrical power exchanges between the various elements of the charger 21.

The primary converter 28 and the secondary converter 34 transfer the instantaneous power delivered by the network R2 (arrow F1 in FIG. 7) to the battery 22.

From the time t1, the instantaneous power Pinst is greater than a power threshold equal to the first power threshold Sp.

The first and second secondary compensation converters 35 and 36, and the second and third high-frequency switching stages 412, 413 of the first and second primary compensation converters 29, 30, charge the first and second storage capacitors such that the instantaneous electrical power received by the battery 22 is equal to the first power threshold Sp.

The instantaneous power exceeding the threshold Sp is transferred to the storage capacitors (arrows F2 in FIG. 7).

Pcomp denotes the instantaneous compensation power equal to the instantaneous electrical power exceeding the first power threshold Sp charged into the storage capacitors.

The storage capacitors store excess energy (FIG. 6).

The voltage across the terminals of the storage capacitors increases (FIG. 5).

From the time t2, the instantaneous power Pinst becomes less than the first power threshold Sp.

The first and second secondary compensation converters 35 and 36, and the second and third high-frequency switching stages 412, 413 of the first and second primary compensation converters 29, 30, discharge the first and second storage capacitors such that the instantaneous electrical power received by the battery 22 is equal to the first power threshold Sp.

The storage capacitors discharge and release the excess energy (FIG. 6) stored previously.

The instantaneous power that is released is transferred to the battery 22 via the first and second secondary compensation converters 35, 36 (arrows F3 in FIG. 7).

The battery 22 receives a constant instantaneous charging power equal to the first threshold, independently of the power variations in the network R2.

FIGS. 8 and 9 illustrate one example of control loops of the compensation device implemented by the processing unit UT.

A first control loop 50 determines the instantaneous compensation power Pcomp (FIG. 8) and a second control loop 51 (FIG. 9) corrects the instantaneous compensation power Pcomp determined by the first loop 50 so as to control and stabilize the peak voltage across the terminals of the first and second storage capacitors, such that said voltage does not exceed the maximum admissible voltage V₁.

The first loop 50 comprises a multiplier 51 that determines the instantaneous power Pinst by multiplying the voltage U2 by the current 12, and a first comparator 52 that compares the instantaneous power Pinst with an instantaneous power setpoint equal to the first power threshold Sp, the instantaneous compensation power Pcomp being equal to the difference between the instantaneous power Pinst and the first power threshold Sp.

The second loop 53 comprises a peak voltage detection device 54 that receives, at input, the voltage Vcapa across the terminals of the first and second storage capacitors, a second comparator 55 that compares the peak voltage determined by the device 54 with the maximum admissible voltage V₁, and a regulator 56 that corrects the instantaneous compensation power Pcomp so as to deliver the corrected instantaneous compensation power Pcom_corr.

As a variant, the energy contained in the battery 22 is delivered by the charger 21 to the network R2, the charging and discharging phases of the storage capacitors 44, 47 being reversed, the power threshold remains equal to the power threshold corresponding to the average power received by the network R2, for example equal to 4000 watts for 16 amperes RMS returned when the network is a 250 V RMS network.

FIG. 10 illustrates a second embodiment of the transformer connecting the primary and secondary circuits of the charger 21.

The transformer comprises a three-phase transformer 60 comprising three power pads 61, 62, 63, a free flux pad 64, three primary coils 65, 66, 67 wound respectively around the power pads 61, 62, 63, and three secondary coils 68, 69, 70 wound respectively around the power pads 61, 62, 63.

The primary coils 65, 66, 67 are furthermore respectively connected to the high-frequency switching stages of the primary power converter 28, of the first and second primary compensation converters 29, 30, and the secondary coils 68, 69, 70 are respectively connected to the secondary power converter 34, to the first and second secondary compensation power converters 35, 36.

The power pads 61, 62, 63 are arranged in the three-phase transformer 60 such that the mutual inductances between the primary coils 65, 66, 67 are the same, this condition being satisfied by an equal distance between the power pads, and such that the free flux pad 64 is equidistant from each of the power pads.

As a variant, equality between the mutual inductances may be achieved by changes in the magnetic properties of the material of the transformer.

The transformer comprising the three-phase transformer 60 makes it possible to reduce the size of the transformer and thus to further reduce the size of the charger 21 compared to the embodiment of the transformer comprising the three single-phase transformers 25, 26, 27.

The size of the three-phase transformer 60 is half the overall size of the three single-phase transformers 25, 26, 27.

Furthermore, the three-phase transformer 60 makes it possible to improve the efficiency of the charger 21 by reducing magnetic losses due to its smaller volume.

When the charger 21 comprises the two switchable storage capacitors and is connected to the single-phase network R2, the high-frequency switching stages of the first and second primary compensation power converters 29, 30 are controlled in phase opposition so as to limit the magnetic flux generated in the magnetic circuit of the three-phase transformer 60 so as to further reduce magnetic losses.

When the charger 21 is connected to a three-phase network, the free flux pad 64 makes it possible to balance the magnetic fluxes of the three power pads 61, 62, 63.

1-11. (canceled)

12. A battery charger for a motor vehicle, comprising a primary electrical power converter and a secondary electrical power converter that are connected by a transformer, the primary power converter and the secondary power converter being configured to transfer a maximum instantaneous power delivered by an electrical power supply network or a battery, respectively, to the battery or to the electrical power supply network, the charger comprising:
at least one primary compensation electrical power converter comprising a high-frequency switching stage connected at output to the transformer;
a filter capacitor connected between two input terminals of the high-frequency switching stage of the primary compensation converter;
at least one secondary compensation electrical power converter connected to the primary compensation converter via a transformer; and
a switchable storage capacitor connected between the two input terminals of the high-frequency switching stage of the primary compensation converter,
the secondary compensation electrical power converter and the high-frequency switching stage of the primary compensation converter being configured to charge or discharge the storage capacitor based on an instantaneous power setpoint.

13. The charger as claimed in claim 12, further comprising:
a second switchable storage capacitor connected between the two input terminals of a second high-frequency switching stage of a second primary compensation electrical power converter; and
a second secondary compensation electrical power converter connected to the second primary compensation converter via a transformer,
the second secondary compensation converter and the second high-frequency switching stage of the second primary compensation converter being configured to charge or discharge the second storage capacitor based on the instantaneous power setpoint equal to a constant first power threshold.

14. The charger as claimed in claim 13, wherein the primary electrical power converter comprises a third high-frequency switching stage, the transformer to which the primary electrical power converter is connected is of three-phase type and comprises three power pads, a free flux pad, three primary coils each wound around a different power pad and connected to a different high-frequency switching stage, and three secondary coils each wound around a different power pad, each secondary coil being connected to the secondary electrical power converter or to one of the secondary compensation converters, the power pads being arranged in the transformer such that mutual inductances between the primary coils are the same, this condition being satisfied by an equal distance between the power pads, and such that the free flux pad is equidistant from each of the power pads.

15. A motor vehicle comprising:
a battery; and
the charger as claimed in claim 12, the battery being connected to the secondary circuit.

16. A method for exchanging electrical energy between a battery for a motor vehicle and a single-phase electrical power supply network both connected to a battery charger, comprising controlling a primary electrical power converter and a secondary electrical power converter so as to transfer a maximum instantaneous power delivered by an electrical power supply network or a battery, respectively, to the battery or to the electrical power supply network, the method comprising:
switching a switchable storage capacitor arranged in parallel with a filter capacitor between two input terminals of a high-frequency switching stage of at least one primary compensation electrical power converter of the charger such that the storage capacitor is connected to the two input terminals, and
controlling at least one secondary compensation electrical power converter of the charger connected to the primary compensation power converter via a transformer of the charger and controlling the high-frequency switching stage of the primary compensation converter so as to charge or discharge the storage and filter capacitors based on an instantaneous power setpoint.

17. The method as claimed in claim 16, further comprising:
switching a second switchable storage capacitor of a second primary compensation electrical power converter such that the second storage capacitor is connected to two input terminals of a second high-frequency switching stage of the second primary compensation electrical power converter; and
controlling a second secondary compensation electrical power converter connected to the primary compensation electrical power converter via the transformer and controlling the second high-frequency switching stage of the second primary compensation converter so as to charge or discharge the second storage capacitor based on the instantaneous power setpoint.

18. The method as claimed in claim 16, wherein the primary electrical power converter comprises a third high-frequency switching stage, wherein the transformer is of three-phase type and comprises three power pads, a free flux pad, three primary coils each wound around a different power pad and connected to a different high-frequency switching stage, and three secondary coils each wound around a different power pad, each secondary coil being connected to the secondary electrical power converter or to one of the secondary compensation converters, the power pads being arranged in the transformer such that mutual inductances between the primary coils are the same, this condition being satisfied by an equal distance between the power pads, and such that the free flux pad is equidistant from each of the power pads.

19. The method as claimed in claim 16, wherein, when the instantaneous power delivered by the single-phase electrical power supply network is greater than the instantaneous power setpoint equal to a first power threshold, each secondary compensation electrical power converter and the high-frequency switching stage of each primary compensation converter are controlled so as to charge each switchable storage capacitor and each filter capacitor.

20. The method as claimed in claim 16, wherein, when the instantaneous power delivered by the single-phase electrical power supply network is less than the instantaneous power setpoint equal to a first power threshold, each secondary compensation electrical power converter and the high-frequency switching stage of each primary compensation electrical power converter are controlled so as to discharge each switchable storage capacitor and each filter capacitor.

21. The method as claimed in claim 16, wherein, when the instantaneous power delivered by the battery is greater than the instantaneous power setpoint equal to a first power threshold, each secondary compensation electrical power converter and the high-frequency switching stage of each primary compensation electrical power converter are controlled so as to charge each switchable storage capacitor and each filter capacitor such that the instantaneous electrical power received by the single-phase electrical network is equal to the second power threshold.

22. The method as claimed in claim 16, wherein, when the instantaneous power delivered by the battery is less than the power threshold equal to a first power threshold, each secondary compensation electrical power converter and the high-frequency switching stage of each primary compensation electrical power converter are controlled so as to discharge each switchable storage capacitor and each filter capacitor.
